(19) United States
(12) Patent Application Publication
(10) Pub. No.: US 2009/0080177 A1
(43) Pub. Date: Mar. 26, 2009

(54) ELECTROLUMINESCENT LIGHT (EL) ORNAMENTS AND METHOD THEREFOR

(76) Inventor: Stephen Richman, Las Vegas, NV (US)

Correspondence Address: WEISS & MOY PC, 4204 NORTH BROWN AVENUE, SCOTTSDALE, AZ, 85251, US

(21) Appl. No.: 11/858,336

(22) Filed: Sep. 20, 2007

(51) Int. Cl. H05B 33/00; B23P 17/04

(52) U.S. Cl. 362/84; 29/592.1

(57) ABSTRACT

A controllable lighted ornament has a body member having a hollow interior section. An electroluminescent (EL) light panel is coupled to an outer surface of the body member. The EL light panel has a multi-color/sectional design. A control circuit is coupled to the EL light panel and housed in the hollow interior of the body member. The control circuit allows for individually controlling the lighting of each color/section of the multi-color/sectional design. A power supply is coupled to the control circuit.

### FIELD OF THE INVENTION

This invention relates to decorative lights and, more specifically, to an electroluminescent light ornament which allows for controlled lighting of a multi-color display on the ornament and further reduces the risk of electrical fires.

### BACKGROUND OF THE INVENTION

Ornamental lights such as Christmas string lights are strands of electric lights used to decorate homes, public/commercial buildings, Christmas trees, and the like during the holiday season. Christmas string lights generally come in many different configurations and colors. The types of lamps used in Christmas lighting sets may be based on a variety of technologies such as incandescent light bulbs, light emitting diodes (LEDs), and the like.

Incandescent and LED-based light sets generally are comprised of a line-operated AC string with a male plug on one end and a female socket on the other end wherein each lamp is connected in series on the string. The female socket may be connected end-to-end with other similar strings. The gauge of wire used and the power consumption of each string will determine how many strings can be safely daisy-chained this way, or whether the end string will have diminished voltage and brightness

While Christmas lighting has been used for many years, the technology used for them has not changed very significantly. Most Christmas lighting still uses incandescent or LED-based light bulbs. These types of lights generate a lot of heat which dry out live Christmas trees increasing the likelihood of a fire. Furthermore, lose or broken bulbs may also cause accidental fires to form. Another problem with current Christmas lighting is that there is very little ability to control the lighting. The only animation that one can perform with current Christmas lighting is the ability to have the lights blink.

Therefore, a need existed to provide a device and method to overcome the above problem.

### SUMMARY OF THE INVENTION

In accordance with another embodiment of the present invention, a controllable lighted ornament has a body member having a hollow interior section. An electroluminescent (EL) light panel is coupled to an outer surface of the body member. The EL light panel has a multi-color/sectional design. A control circuit is coupled to the EL light panel and housed in the hollow interior of the body member. The control circuit allows for individually controlling the lighting of each color/section of the multi-color/sectional design. A power supply is coupled to the control circuit.

In accordance with another embodiment of the present invention, a controllable lighted ornament has a body member having a hollow interior section. A flat surface is formed on the body member. An electroluminescent (EL) light panel is coupled to the flat surface of the body member. The EL light panel has a multi-color/sectional design. A control circuit is coupled to the EL light panel and housed in the hollow interior of the body member. The control circuit allows for individually controlling the lighting of each color/section of the multi-color/sectional design. The control circuit has a plurality of pairs of conductors. Each pair of conductors is coupled to an individual color/section of the multi-color/sectional design. A controller is coupled to each of the plurality of pairs of conductors for individually controlling the lighting of each color/section of the multi-color/sectional design. A power supply is coupled to the control circuit.

In accordance with another embodiment of the present invention, a method of forming a controllable lighted ornament is disclosed. The method comprises: providing a body member having a hollow interior section; coupling an electroluminescent (EL) light panel to an outer surface of the body member, the EL light panel having a multi-color/sectional design; coupling a control circuit to the EL light panel; housing the control circuit in the hollow interior of the body member wherein the control circuit individually controlling the lighting of each color/section of the multi-color/sectional design; and coupling a power supply to the control circuit.

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is a simplified functional block diagram of an Electroluminescent (EL) light used in the EL light ornament of the present invention;

FIG. 2 is an elevated perspective view of an EL light ornament of the present invention;

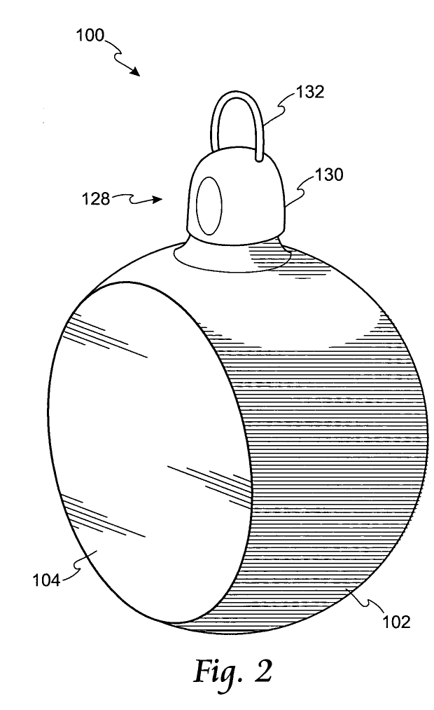

FIG. 3 is a back view of the EL light ornament of the present invention;

FIG. 4 is an exploded view of the EL light ornament of the present invention;

FIG. 5 is an elevated perspective view of the EL light ornament of the present invention with an alternative source of

FIG. 6 is a simplified functional block diagram of the control unit of the EL light ornament of the present invention.

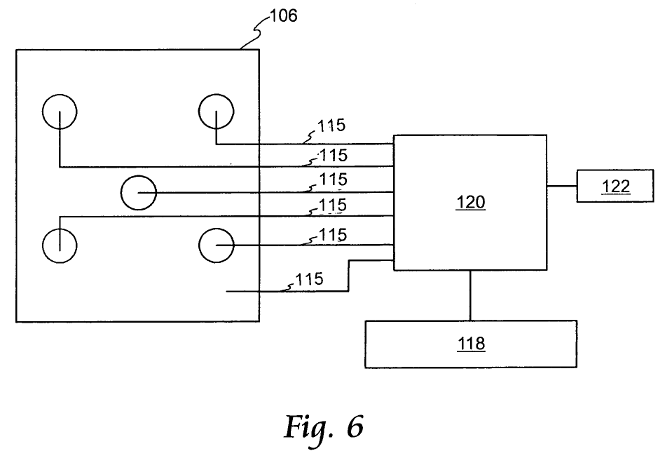

### DETAILED DESCRIPTION

With reference now to the Figures, an electroluminescent (EL) light ornament 100 is shown. The EL light ornament 100 has a body member 102. The body member 102 will have a hollow interior section 102A. In the Figures, the body member 102 has a geometrical shape of a cylindrical ball having a flat front surface 104. While a flat surface 104 is shown, the body member 102 may be a fully rounded cylindrical ball. The body member 102 may also have other geometrical configurations without departing from the spirit and scope of the present invention.

The body member 102 is generally formed of a light weight material. The material used may be clear, semi-opaque, or non-transparent. Some examples of the materials that may be used include, but are not limited to: glass, plastic, a light weight metal such as tin or aluminum, or other similar materials. The listing of the above materials is given as an example and should not be seen as to limit the scope of the present invention.

Coupled to the surface of the body member 102 is an electroluminescent (EL) display 106. In the Figures, the EL display 106 is coupled to the flat front surface 104 of the body member 102. By providing a flat front surface 102, the EL display 106 is more visible. However, as stated above, the flat front surface 104 is not required and the EL display 106 may be could to a rounded surface of the body member 102.

The EL display 106 will have a multi-sectional and/or color design (hereinafter multi-color). The multi-color design can take on any form such as that of a college/professional sports team logo, cartoon character, holiday scene/character, corporate logos, tourist attractions, and the like. The listing of the above is given as an example and should not be seen as to limit the scope of the present invention. Other types of multi-color designs may be used without departing from the spirit and scope of the present invention.

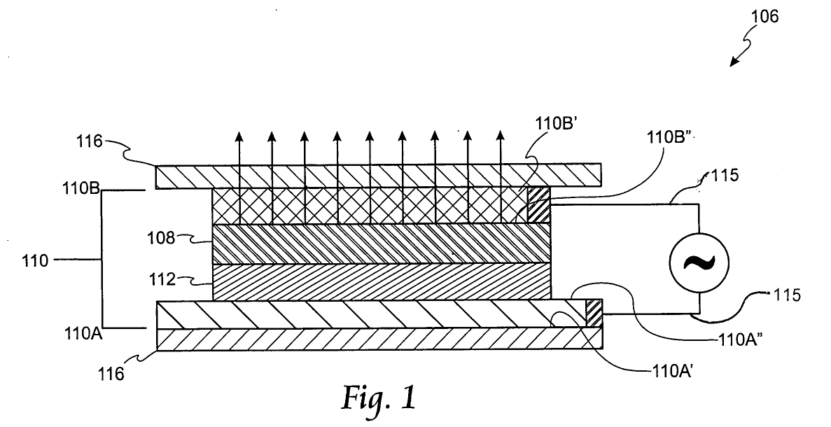

The EL display 106 is an actually an EL lamp. The EL display 106 will emit light. However, unlike a traditional lamp, instead of creating light by heating a filament, the EL display 106 uses a phosphorescent material 108 which glow when exposed to a small electrical current. As shown in FIG. 1, the EL display 106 has a pair of electrodes 110. The pair of electrodes 110 generally comprises a bottom electrode 110A and a top electrode 110B. At least one of the electrodes 110A or 110B will be transparent to allow the escape of the produced light. As shown in FIG. 1, the top electrode 110B is transparent. In the embodiment of FIG. 1, the top electrode 110B uses a transparent Indium Tin Oxide (ITO) conductive ITO film. Glass coated with indium oxide or tin oxide is may also be used as the transparent electrode, the top electrode 110B. The bottom electrode 110A is generally comprised of an insulator, such as glass coated with a reflective metal.

A dielectric layer 112 is formed on top of the bottom electrode 110A. A phosphorescent material 114 is then disposed on the dielectric layer 112. The phosphorescent material 114 may be applied to form multi-color designs as described above. A protective film 116 may be placed on a surface 110B′ of the top electrode 110B opposite of the surface 110B″ coupled to the phosphorescent material 108. The protective film 116 may also be placed on a surface 110A′ of the bottom electrode 110A opposite of the surface 110B″ coupled to the dielectric layer 112. Conductors 116 are then coupled to the electrodes 110A or 110B. In general, the conductors 116 are copper or aluminum foil conductors. The conductors 116 are then coupled to a power supply 118. The phosphorescent material 108 will glow when exposed to a small electrical current from the power supply 118.

Different sets of conductors 116 are coupled to different colors/sections of the multi-color design. This will allow individual control of the lighting of the multi-color design. In accordance with on embodiment of the present invention, a controller 120 is coupled to each of the sets of conductors 116 and to the power supply 118. The controller 120 will control which colors/sections of the multi-color design will be illuminated. An activation device 122 may be coupled to the controller 120. The activation device 122 will allow one to activate or deactivate the illumination of the EL light ornament 100. The activation device may be a switch, a motion detector, or the like. The listing of the above is given as an example and should not be seen as to limit the scope of the present invention.

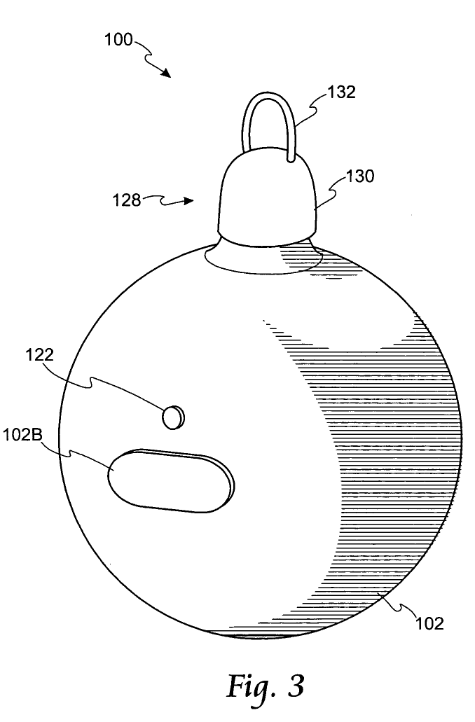

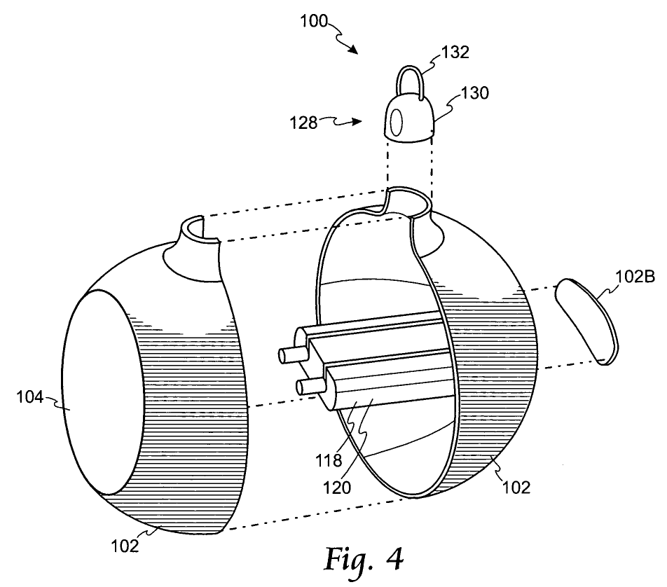

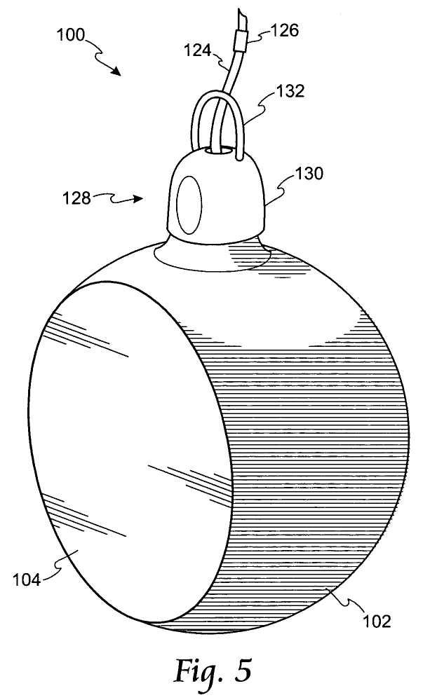

As shown more clearly in FIG. 4, the power supply 118 and the controller 120 are stored within the body member 102. The body member 102 may be formed of two haves that are removably coupled together to allow one to open the body member 102 to replace the power supply 118. Alternatively, the body section 102 may have a replaceable cover 102B to allow the power supply to be removed and replaced. In the embodiment depicted in FIG. 4, the power supply 118 is a battery. Alternatively, as shown in FIG. 5, the EL light ornament 100 is coupled to a wire 124 having a connector 126 which may be coupled into a standard string of holiday lights. If an activation device 122 is provided, the activation device 122 is generally located on the back surface of the body member 102 as shown in FIG. 3.

A hanging device 128 is coupled to a top area of the body member 102. The hanging device 128 generally has a base unit 130 which attaches to the body member 102. An arch unit 132 is coupled to the base unit 130. The arch unit 132 allows for a hook or other device to be coupled to the body member 102 so that the EL light ornament 100 may be hung from a branch of a tree or other object.

While embodiments of the disclosure have been described in terms of various specific embodiments, those skilled in the art will recognize that the embodiments of the disclosure can be practiced with modifications within the spirit and scope of the claims.

What is claimed is:

1. A controllable lighted ornament comprising:
a body member having a hollow interior section;
an electroluminescent (EL) light panel coupled to an outer surface of the body member, the EL light panel having a multi-color/sectional design;
a control circuit coupled to the EL light panel and housed in the hollow interior of the body member, the control circuit individually controlling the lighting of each color/section of the multi-color/sectional design; and
a power supply coupled to the control circuit.

2. A controllable lighted ornament in accordance with claim 1 further comprising a flat surface formed on the body member, the EL light panel coupled to the flat surface to allow the EL light panel to be more visible.

3. A controllable lighted ornament in accordance with claim 1 further comprising:
wiring coupled to the control circuit; and
a connector coupled to the wiring for attaching the controllable lighted ornament to a light bulb socket of a light strand.

4. A controllable lighted ornament in accordance with claim 1 wherein the control circuit comprises:
a plurality of pairs of conductors, wherein each pair of conductors is coupled to an individual color/section of the multi-color/sectional design; and
a controller coupled to each of the plurality of pairs of conductors.

5. A controllable lighted ornament in accordance with claim 1 wherein the power supply is a battery housed within the hollow interior of the body member.

6. A controllable lighted ornament in accordance with claim 1 wherein the body section comprises:
a pair of halves removably coupled together;
wherein the power supply is a battery housed within the hollow interior of the body member.

7. A controllable lighted ornament in accordance with claim 1 further comprising a switching device coupled to the body section and the control circuit to activate and deactivate the controllable lighted ornament.

8. A controllable lighted ornament in accordance with claim 1 further comprising a hanging mechanism coupled to a top area of the body member for attaching the controllable lighted ornament to an object.

9. A controllable lighted ornament comprising:
a body member having a hollow interior section;
a flat surface formed on the body member;
an electroluminescent (EL) light panel coupled to the flat surface of the body member, the EL light panel having a multi-color/sectional design;
a control circuit coupled to the EL light panel and housed in the hollow interior of the body member, the control circuit individually controlling the lighting of each color/section of the multi-color/sectional design, wherein the control circuit comprises:
a plurality of pairs of conductors, wherein each pair of conductors is coupled to an individual color/section of the multi-color/sectional design; and
a controller coupled to each of the plurality of pairs of conductors; and
a power supply coupled to the control circuit.

10. A controllable lighted ornament in accordance with claim 9 further comprising:
wiring having a first end coupled to the control circuit; and
a connector coupled to a second end of the wiring for attaching the controllable lighted ornament to a light bulb socket of a light strand.

11. A controllable lighted ornament in accordance with claim 9 wherein the power supply is a battery housed within the hollow interior of the body member.

12. A controllable lighted ornament in accordance with claim 9 wherein the body section comprises a pair of halves removably coupled together.

13. A controllable lighted ornament in accordance with claim 12 wherein the power supply is a battery housed within the hollow interior of the body member.

14. A controllable lighted ornament in accordance with claim 9 further comprising a switching device coupled to the body section and the control circuit to activate and deactivate the controllable lighted ornament.

15. A controllable lighted ornament in accordance with claim 9 further comprising a hanging mechanism coupled to a top area of the body member for attaching the controllable lighted ornament to an object.

16. A method of forming a controllable lighted ornament comprising:
providing a body member having a hollow interior section;
coupling an electroluminescent (EL) light panel to an outer surface of the body member, the EL light panel having a multi-color/sectional design;
coupling a control circuit to the EL light panel;
housing the control circuit in the hollow interior of the body member wherein the control circuit individually controlling the lighting of each color/section of the multi-color/sectional design; and
coupling a power supply to the control circuit.

17. The method of claim 16 further comprising providing a body member having a flat surface formed thereon, the EL light panel coupled to the flat surface to allow the EL light panel to be more visible.

18. The method of claim 16 further comprising:
providing wiring coupled to the control circuit; and
providing a connector coupled to the wiring for attaching the controllable lighted ornament to a light bulb socket of a light strand.

19. The method of claim 16 wherein the control circuit comprises:
a plurality of pairs of conductors, wherein each pair of conductors is coupled to an individual color/section of the multi-color/sectional design; and
a controller coupled to each of the plurality of pairs of conductors.

20. The method of claim 16 wherein the power supply is a battery housed within the hollow interior of the body member.
